(19) United States
(12) Patent Application Publication
(10) Pub. No.: US 2024/0415102 A1
(43) Pub. Date: Dec. 19, 2024

(54) ADDITIVE BASED ON VITAMINS, MINERALS AND OTHER ORGANIC COMPOUNDS THAT IMPROVES BIOFILTER EFFICIENCY IN A RECIRCULATING AQUACULTURE SYSTEM (RAS)

(71) Applicant: Rodrigo Lazarraga Muñoz, Puerto Varas (CL)

(72) Inventor: Rodrigo Lazarraga Muñoz, Puerto Varas (CL)

(21) Appl. No.: 18/575,635

(22) PCT Filed: May 24, 2022
(86) PCT No.: PCT/CL2022/050054

§ 371 Date: Sep. 3, 2024

(30) Foreign Application Priority Data
Jul. 1, 2021 (CL) 1761-2021

(51) Int. Cl. A01K 63/04; C02F 1/68; C02F 3/34; C02F 103/20

(52) U.S. Cl. CPC A01K 63/04; C02F 1/68; C02F 3/341; C02F 2103/20; C02F 2305/06

(57) ABSTRACT

The present invention relates to an additive that comprises compounds of plant and mineral extracts, useful in recirculating aquaculture system that will significantly improve efficiency of the biofilter used in said systems, thus reducing the levels of toxic chemicals such as ammonium and nitrite. Furthermore, this additive will also reduce oxygen consumption and provide better overall water quality conditions. This implies an improvement in the efficiency of these systems, thus achieving farming of different fish species with lower mortality, better feed conversion, and growth rate.

### FIELD OF THE INVENTION

The present disclosure relates to an additive based on vitamins, minerals, among others, and its use to improve the efficiency of biofilters used in recirculating aquaculture systems (RAS) which will allow improving the ammonia treatment, and in general, the quality of the water in said systems.

### BACKGROUND OF THE INVENTION

Nowadays, aquaculture is a protein key provider around the world by providing several species such as salmon, tilapia, catfish, or others. Due to this, thousands of tons of fish are farmed every day in freshwater hatcheries and sea cages to be consumed throughout the world.

An example of on-land hatcheries is the one that farms salmon wherein this species is farmed from the egg stage until it can be delivered to the sea in the case of fish going to the sea and which are called smolt the size of which is approximately 100-120 grams.

In general, salmon aquaculture or of any other species can be carried out by means of three different approaches:
(A) Continuous flow System: a traditional and simple approach system which consists in placing a fish hatchery next to a river or stream and taking water from them. This water is introduced and placed in tanks with fish and then, as necessary, they can be discharged back to the river or stream. This can be done in an inexpensive way without pumps only using a height differential, however, large quantities of water having very strict environmental laws are needed, which makes this approach more difficult to implement. In addition, it is not possible to perform a control regarding the temperature, quality and quantity of water being provided by the river or stream, which can affect the production of fish since these characteristics can vary from one season to the next. On the other hand, fish farming depends to a large extent on the quality of the water, and without a control of the water used, outbreaks of diseases can occur. This system does not require to add oxygen or to perform a chemical control of the water, nevertheless, the density of the fish population is low, normally 10 to 20 kg/m³ of water.
(B) Reuse System: System which by means of a flow through the hatchery increases the quantity of fish that can be farmed, thereby transforming the reuse installation where 80% of the water used is pumped and only 20% of fresh or make-up water is added. However, oxygen must be added and the CO₂, produced must be eliminated through a degasser, said action allows for a higher density of fish in the hatchery or installation. However, with less than 20% make-up water, the quality of the water is affected due to the increased concentration of ammonia in the system. As a general rule, mass balance equations show that the steady state level of a chemical substance excreted by the fish, in a system having a reuse or recirculation of water, will be 1% replenishment. Therefore, in a reuse system, the ammonia level tends to be 5 times higher than the amount produced by the fish. For this system, the investment is moderate, however no temperature control as well as no disease control is in place due to the high level of freshwater addition.
(C) Recirculation system (RAS): this system is the most complex of all, since it requires a significantly greater investment, however, offers several key benefits. The RAS system generally reuses up to 99% of its water and only has a composition of freshwater in the range of 1-2%. This system can have a significantly higher fish density up to 50-80 kg/m³ and in some cases reaching 110 kg/m³. The fish tanks are located in a closed warehouse with strict biological controls; therefore, diseases can be minimized and the water temperature can also be controlled, which allows for a faster growth of the fish.

However, in order to achieve these benefits, the hatchery of a RAS system must include, in addition to the fish tank, the following components:
(a) Feeding systems to provide the fish with food
(b) Pumps to provide pressure and flow of water
(c) Drum filter for the removal of typical solids of up to 40-60 microns
(d) UV, ozone or similar element for disinfection and disease control
(e) pH control by means of calcium carbonate or a similar element
(f) Addition of oxygen through an oxygen cone, venturi or the like
(g) CO₂ degasser
(h) Biofilter
(i) Treatment of sludge and wastewater dumping in order to comply with legal regulations, which means that wastewaters to be dumped must be treated and the sludge generated must be removed by external companies for treatment.
(j) Mortality control: any fish that dies during the process is tabulated and arranged to be removed by external companies. The disposal includes a mashing and storing in a silage environment, that is, preservation by means of the addition of organic and inorganic acids (pH4) such as formic acid or the like, o by means of lactic fermentation mixed with a carbohydrate substrate.
(k) Water replenishment which generally is obtained from a well or stream, water that is disinfected and treated before being used in the RAS system.

It is worth highlighting that component (h), i.e., the biofilter, is one of the key elements in the hatchery using a RAS system and is often a limiting factor. In the biofilter there are elements with a large surface area generically called bio blocks to which bacteria are attached which transform the ammonia produced by the fish first into nitrite (NO₂) and afterwards, from NO₂, produce nitrite (NO₃).

In view of the above, the object of the present application is to address the technical problem related to the production of ammonia which leads to an increase in the concentration of nitrite and nitrate in the biofilter of the hatchery, wherein this component is the main point where the proposed additive works, as explained in further detail below.

Currently, there is a trend to increase the size of the hatchery farmed fish to a post-smolt size of 500 to 600 grams or, in some cases, up to a final commercial size of 5 kilograms. The basic principles of the technologies remain the same, however in order to accomplish the aforementioned, it is necessary to increase the size of the hatchery plant and, thus, the investment.

As mentioned above, the biofilter is a key component of the RAS system, where the feed being delivered to the fish has approximately 50% protein content comprising nitrogen as one of its key components such as an amide radical (NH₂). The proteins in the feed are consumed by the fish and a part is excreted as NH₃ through the gills and another part as undigested protein in the feces.

There is also a part of the food which is not consumed by the fish and that is dissolved in the water. Nitrogen from protein in food and feces eventually breaks down into NH₄⁺ in the water and is bound to the amount excreted through the gills of the fish. The NH₄⁺ or ammonium ion in water is in equilibrium with NH₃, which is dissolved ammonia, an equilibrium that depends on the pH range in which a pH 7 or less begins to predominate the NH₄⁺ (FIG. 1).

In addition, given the fact that this is a recirculating system, the amount of NH₄⁺ increases, depending on the make-up water to 50 times the amount produced by the fish. As is known, both the NH₄⁺ and the NH₃ are toxic to fish depending on the species being farmed and can be found at levels as low as 0.012 ppm.

The current way to avoid toxic levels of NH₄⁺—NH₃ is to transform these compounds into other less toxic forms of nitrogen, which can be done biologically using the following bacteria:

NH₄⁺+2O₂→NO₂⁻+2H₂0 Nitrosomonas

2NO₂⁻+O₂→2NO₃⁻ Nitrobacter

Where nitrite or NO₂⁻ is also toxic to fish at a low level, however nitrate or NO₃⁻ can be supported at higher levels.

The biofilter, which can be a fixed or fluid component, contains a structure of a material that, for example, is made of plastic with a large surface area. The water passes through this biofilter and since it is rich in nutrients, it allows bacteria to slowly begin to attach themselves to its surface. Among the bacteria being attached to the biofilter, there are the Nitrosomonas bacteria that first convert NH₄⁺ in NO₂⁻.

Subsequently, the presence of NO₂⁻ allows for the appearance of Nitrobacter bacteria to convert NO₂⁻ into NO₃⁻. This phenomenon is called filter priming and can take between 14 and 21 days (FIG. 2).

If fish are removed from the farming tank, the bacteria quickly starve due to the lack of food and in this case the biofilter will have to be primed again. This is a major disadvantage of biofilters, unlike mechanical parts such as pumps, biofilters cannot increase or decrease their production, they cannot be replaced in case of failure and depend on the amount of living bacteria which, in turn, depends on the amount of food available for the bacteria to grow, and also depends on the appropriate conditions of oxygen and space.

To further complicate the operation of a RAS system, the 2-step digestion of the NH₄⁺ species means that the levels of NO₂⁻ and NO₃⁻ present in water depend on the rate of digestion of both bacteria and also on the amount of NH₄⁺ being incorporated throughout the day into the water. This amount is not constant throughout the day, as it is highly influenced by the times the fish are fed. Although the biofilter focuses on these 2 bacteria, there are also other bacteria that digest the carbon-based byproducts in the water and compete with these bacteria for space and oxygen in the biofilter. Even under certain anoxic conditions, bacteria can proliferate that generate highly toxic compounds to the fish such as H₂S or CH₄.

That is, the decomposition of solid and dissolved organic waste can be achieved in a recirculation facility by means of this wide variety of naturally occurring bacteria. Different groups of bacteria have unique and different growth requirements, i.e., macro, and micronutrient needs. Since they compete for the same growth substrates and organic raw materials, at times, the availability of specific micronutrients (vitamins and minerals) is the limiting factor for bacterial growth. Due to this reason, the input of selected micronutrients can cause significant and beneficial changes in the nature and efficiency of the dominant bacterial populations.

As previously mentioned, bacteria typically thrive in the biofilter substrate, which is a space where water has a certain residence time and has a large surface area where biofilms of bacteria form. The biofilter material can be made of plastic, metal or other material having different geometrical shapes and can be fixed bed, fluidized bed, with or without injection of air or oxygen.

Recirculating system hatcheries (RAS) are normally designed for a certain number of kilograms of feed per day that can be added and digested by the existing bacteria in the biofilter.

However, there are currently a number of problems that occur in RAS systems such as:
During the biofilter priming phase, very high levels of ammonia and nitrite can be reached.
Any variation in the amount of feed or fish can cause the bacteria levels to be insufficient and the NH₄⁺—NH₃ levels to increase.
Sudden changes in temperature, salinity or the addition of antibiotics can also stimulate a drop in the level of bacteria causing changes in the ammonia and/or nitrite peaks.
High levels of ammonia and/or nitrite can cause depending on exposure death or serious damage to fish at the level of gills and blood metabolism.

In the state of the art there is a wide variety of documents related to the technical field of the present application, such as:

US 2008/210630 (A1) relates to apparatus, methods, and applications for treating wastewater, and more particularly to biological processes for removing pollutants from wastewater. This invention further relates to apparatus and methods for growing microbes on-site at a wastewater treatment facility, and for economically inoculating sufficient microbes to solve various treatment problems rapidly.

US2010/209988 (A1) Microbially colonized charred biological material, such as charcoal, wherein the colonizing microbes are capable of metabolizing at least one selected environmental substance, such as a pollutant, and wherein a selective amount of the substance that is present in the charred material provides protected colonies of environmentally active microbes useful in bioremediation.

However, the state of the art of the technical field of the present application does not disclose or suggest an additive composed of organic micronutrients of plant origin and minerals in specific proportions that allow stimulating all types of bacteria in a recirculation system (RAS) used in aquaculture thus improving the efficiency of biofilters.

The proposed additive is designed to optimize the activity of bacteria located in a biofilter related to the fish farming keeping in mind and considering that the water has to maintain an equilibrium under optimal conditions for the rearing of farmed fish. In addition, there is no additive comprising specific types of nutrients that can be used for stimulating multiple bacteria.

In accordance with the aforementioned, the present application proposes as a technical solution to the previously mentioned problems, an additive that is a product composed of organic micronutrients of plant original and minerals which have been shown to stimulate all types of bacteria that will be useful in all types of biofilters used in aquaculture. Once these micronutrients and minerals are made available to the biological community in wastewater, the metabolic rates of specific bacterial populations increase drastically wherein the beneficial impact of micronutrients is more significant for facultative anaerobic populations.

### SUMMARY OF THE INVENTION

An aspect of the present invention provides an additive that is a product composed of organic micronutrients of plant origin and minerals which have been shown to be useful for stimulating all types of bacteria. Once these micronutrients are made available to a biological community in wastewater, the metabolic rates of bacterial populations can be increased drastically wherein the beneficial impact of micronutrients is more significant for facultative anaerobic populations, which allows to improve the efficiency of biofilters used in RAS systems.

This product comprised of micronutrients consists of a mixture of vitamins, amino acids, and minerals:

Vitamins and other organic compounds:
Vitamin A, including B carotene and retinol 50-90 IU/100 mg
Amino acids including alanine, arginine, aspartic acid, glutamic acid, glycine, histidine, isoleucine, leucine, phenylalanine, proline, serine, threonine, total lysine, tyrosine, valine 0.5-1.0% w/w
Biotin 0.01-0.03% w/w
Cystine 0.05-0.1% w/w
Methionine 0.01% w/w
Folic acid—less than 1 ppm
Inositol 20-34 mg/100 mg
Vitamin B₂ (riboflavin) 0.0001-0.0002% w/w
Choline 5-7.1 mg/100 mg
Tryptophan 0.005-0.01% w/w
Vitamin B₁₂ 0.0008-0.0016% w/w
Pantothenic acid 0.03-0.07% w/w
Vitamin B₆ 0.002-0.004% p/p
Vitamin D₂ and D₃ 0.002-0.004% w/w

Minerals:
calcium 0.05-0.073% w/w
Iron 0.002-0.005% w/w
copper 1-200 mg/l
potassium 0.05-0.15% w/w
boron 0.5-1.0 mg/l
magnesium 0.02-0.04% w/w
manganese 4000-9000 mg/l
molybdenum 0.02-0.05 mg/l
nickel 10-14 mg/l
vanadium 0.01-0.02 mg/l
zinc 4.000-9.500 mg/l.

This additive by stimulating the different types of bacteria will achieve better digestion of feces and undigested food, which will allow less protein to be converted into ammonia, thereby reducing the general levels of ammonia per kilo of biomass.

This additive will also allow facultative bacteria to digest the carbon side of the organic matter faster thus allowing more space and oxygen to be available in the biofilter for the ammonium and nitrite converting bacteria.

Furthermore, the proposed additive will be able to inhibit anoxic bacteria that produce compounds such as H₂S or CH₄.

In summary, the proposed additive composed of micronutrients and minerals, added to a recirculating RAS system in aquaculture will significantly improve the efficiency of the biofilter by reducing the levels of toxic chemical compounds such as ammonium and nitrite, reducing oxygen consumption and providing better general conditions of water quality that cause lower mortality, feed conversion ratio hereinafter also known as FCR (Feed Conversion Ratio) and daily growth rate also known as SGR (Standard Growth Rate).

### BRIEF DESCRIPTION OF FIGURES

FIG. 1. Equilibrium of species NH₄⁺—NH₃ in an aqueous medium depending on the pH.

FIG. 2. filter priming phenomenon that can take between 14 and 21 days.

FIG. 3. Stages of biological reactions in wastewater treatment plants.

FIG. 4. Ammonium levels expressed as equivalent of nitrogen in mg/l. The average of 3 samples per day of control group 4A and test group 4B.

FIG. 5. Nitrite levels expressed as equivalent of nitrogen in mg/l. The average of 3 samples per day of control group 4A and test group 4B.

FIG. 6. Ammonium levels expressed as equivalent of nitrogen in mg/l. Food consumed daily by group in grams. The average of 3 samples per day of control group 4A and test group 4B.

FIG. 7. Nitrite levels expressed as equivalent of nitrogen in mg/l. An average of 3 samples per day of control group 4A and test group 4B.

FIG. 8. Nitrate levels expressed as equivalent of nitrogen in mg/l. An average of 3 samples per day of control group 4A and test group 4B.

FIG. 9. Ammonium levels expressed as equivalent of nitrogen in mg/l, food consumed, food delivered.

FIG. 10. Daily growth rate of fish that considers the average growth rate in 4 periods of time.

FIG. 11. Fish tank. Control group: greater turbidity of the water.

FIG. 12. Fish tank. Test group: lower turbidity in the water.

FIG. 13. Centrifugal filter. Control group: significant amount of sludge in filter.

FIG. 14. Centrifugal filter. Test group: reduction of sludge in filter.

FIG. 15. CO₂ degasser. Control group: significant sediment.

FIG. 16. CO₂ degasser. Test group: sediment reduction.

FIG. 17. Biofilter. Control group: small biofilm adhered to the bio blocks.

FIG. 18. Biofilter. Test group: large amounts of biofilm adhered to the bio blocks.

FIG. 19. Hydrogen sulfide H₂S levels expressed in mg/l for samples per day of control group 4A and test group 4B.

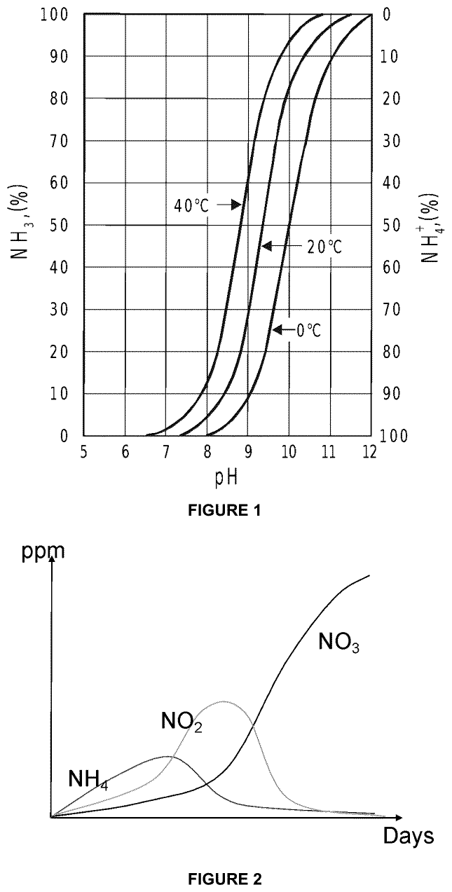

### DETAILED DESCRIPTION OF THE INVENTION

In order to provide a clear and detailed description of the present invention, a specific example, using salmon aquaculture will be provided, a major export species compared to other aquaculture species. However, it should be kept in mind that the technical problem and the state of the art for the technical field addressed in this application must be considered of a similar nature for any species cultivated by aquaculture.

Solid and dissolved organic waste in recirculating hatcheries are degraded by bacteria that are generally classified by their ability to survive and multiply in the presence or absence of oxygen.

Aerobic bacteria function in the presence of oxygen, anaerobic bacteria function in the absence of oxygen, and facultative bacteria can function in the presence or absence of oxygen.

All biological wastewater treatment plants include one or more of these three main bacterial groups. Typically, the rate-limiting step in the removal of organic solids from wastewater is hydrolysis. An important factor contributing to this problem is that hydrolyzing bacteria do not function at full capacity due to limitations related to the availability of nutrients necessary for their operation and activity.

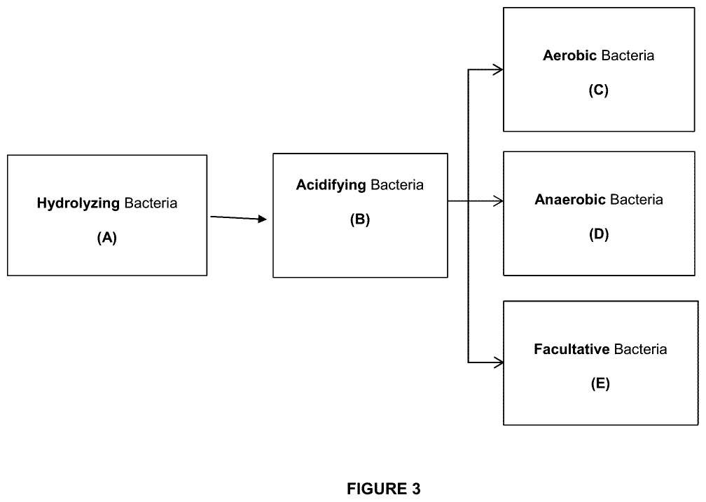

FIG. 3 shows in general a biological treatment process, said process comprises that the hydrolyzing bacteria convert organic solids, fatty oils and fats (FOG) into volatile fatty acids (A), acidifying bacteria converting fatty acids into acetic acid (B), that the aerobic bacteria convert 75% of the acetic acid into new biosolids and that consume O₂, release H₂O, NH₃ and CO₂ (C), that the anaerobic bacteria convert 10% of the acetic acid into new biosolids and the rest of the acetic acid into CO₂, H₂S, CH₄ (D), and that the facultative bacteria convert 90% of the acetic acid into H₂O, CO₂, CH₄ and 10% into dense biosolids with greater fluidity (E).

Once the micronutrients and minerals are made available to the biological community in wastewater, the metabolic rates of specific bacterial populations increase drastically. Comparatively, the beneficial impact of micronutrients is more significant for facultative anaerobic populations. Micronutrients allow facultative anaerobes to actively degrade organic compounds in unaerated portions which are not normally designed to work in reactors such as surge tanks or settling tanks, making the entire plant more efficient.

As a result, facultative anaerobes convert a much higher proportion of acetic acid into atmospheric gases, rather than additional biosolids. This also results in a significantly lower oxygen demand in aerobic bioreactors because a significant part of the acetic acid load is diverted from pure aerobes to facultative anaerobes. The net effect is a less volume of sludge/biosolids requiring processing and disposal and less energy demand for aeration.

In systems related to aquaculture, when there is improved digestion of feces and undigested food this has an impact on the fact that less proteins are converted into ammonia, thus reducing general levels of ammonia per kilo of biomass.

On the other hand, facilitating faster digestion of the carbon side of the organic matter by facultative bacteria allows for increased space and oxygen availability in the biofilter for ammonium and nitrite converting bacteria.

Nitrobacter and Nitrosomonas bacteria are the main bacteria that convert ammonia into nitrite and then produce nitrate.

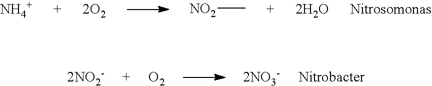

The proposed additive enables an elevated metabolism rate in these bacteria, leading to a stable state of the biofilter for approximately 14 days. This results in a reduced peak of NH₄^{+ l and NO}₂, along with an enhanced overall capacity for processing feed in the biofilter. Consequently, it contributes to better water quality.

Additionally, the proposed additive, which is a product comprised of organic micronutrients of plant origin, has been proven to stimulate all types of bacteria present in biofilters.

This product, composed of micronutrients, consists of a mixture of vitamins, amino acids, and minerals.

Vitamins and other organic compounds:
Vitamin A, including B carotene and retinol 50-90 IU/100 mg

Amino acids including alanine, arginine, aspartic acid, glutamic acid, glycine, histidine, isoleucine, leucine, phenylalanine, proline, serine, threonine, total lysine, tyrosine, valine 0.5-1.0% w/w
Biotin 0.01-0.03% w/w
Cystine 0.05-0.1% w/w
Methionine 0.01% w/w
Folic acid—less than 1 ppm
Inositol 20-34 mg/100 mg
Vitamin B₂ (riboflavin) 0.0001-0.0002% w/w
Choline 5-7.1 mg/100 mg
Tryptophan 0.005-0.01% w/w
Vitamin B₁₂ 0.0008-0.0016% p/p
Pantothenic acid 0.03-0.07% w/w
Vitamin B₆ 0.002-0.004% p/p
Vitamin D₂ and D₃ 0.002-0.004% w/w

Minerals:
calcium 0.05-0.073% w/w
Iron 0.002-0.005% w/w
copper 1-200 mg/l
potassium 0.05-0.15% w/w
boron 0.5-1.0 mg/l
magnesium 0.02-0.04% w/w
manganese 4000-9000 mg/l
molybdenum 0.02-0.05 mg/l
nickel 10-14 mg/l
vanadium 0.01-0.02 mg/l
zinc 4000-9500 mg/l.

The proposed additive has 3 aspects that are not evident in the current state of art. Although this additive comprises compounds that belong to generic categories of vitamins, amino acids, and minerals it features specific proportions and ingredients designed for a distinct purpose that is related to the improved yield of a biofilter used in aquaculture within a RAS system.

The above implies the following:
(A) Use in aquaculture: the additive, in addition to being an innocuous product for fish, studies have shown that it allows to provide a better water quality, since it has a positive impact on an improved conversion rate and a better growth rate of fish.
(B) The set of components of the additive allows accelerating the bacterial metabolism that processes ammonium, nitrite, and carbon, and, at the same time, anaerobic bacteria, which produce H₂S— a chemical compound that is toxic to fish-, are inhibited.
(C) The proposed additive, in addition, can make the organic material adhere better to the biofilter substrate, thus providing a greater biofilm per cubic meter of this substrate.
(D) The proposed additive is designed to be used in a biofilter where the water is reused by fish under aquaculture operational conditions.

The combination of point B and C achieves a significant increase in the capacity of bacteria in the water to digest ammonium and nitrite, thus allowing the biofilter to process a greater amount of kilograms of food per day per cubic meter of biofilter.

These advantages will be obvious from the examples below.

The following examples aim to illustrate the invention and its preferred embodiments, however they should not be considered, under any circumstances, as limiting the scope of protection of the invention which is determined by the content of the claims attached to the present application.

### APPLICATION EXAMPLES

In order to verify the efficiency of the proposed additive, two tests were carried out at the ATC and R&D facilities in Puerto Montt, Chile. The ATC laboratories are a world class R&D facility owned by Biomar and Empresas Aquachile, which are used to test vaccines, feed, disease control and other aquaculture-related experiments.

In order to carry out these tests, the proposed additive was added by means of a peristaltic pump or the like with flow control to the aquaculture recirculation system wherein there is a water tank and no direct contact between the additive and the fish being farmed, just as it is in the biofilter, rotary drum filter or sump pump reservoir.

The proposed additive is added in an amount between 12 to 20 ml of additive per kilo of food that is provided to the fish, determined based on the monitored concentration of ammonia and that can reach a constant value.

In order to maintain an oxygen level of not less than 35% in the water leaving the biofilter, a means that supplies oxygen to the water pumped to the biofilter must be employed, either through a venturi or an oxygen cone. This should be monitored online through an oxygen sensor that operates a control valve incorporating oxygen via one of the previously mentioned injection methods.

### Example 1

### Experimental Design

In a recirculation system (RAS), over a period of 30 days, the activation time or priming of a biofilter was evaluated by means of the proposed additive, for which 1500 fish of the Atlantic salmon species (Salmo salar) were selected with an average weight of 75.8 grams. These were distributed in the same biomass in rooms 4A and 4B of the ATC Patagonia research center using 5 tanks of 0.5 m³ each (150 fish/tank) where fish were fed with a commercial diet to satiety and kept in a freshwater recirculation system with a photoperiod of 24 hours of light at a temperature of 14±0.2° C. and, at a pH 7.5±0.3.

The control group without additive was kept in room 4A and in room 4B was kept the test group where the proposed additive was added by means of a pulse dosing pump.

On the other hand, both the control group and the test group were kept under the same operational conditions of biomass, feed, and abiotic parameters of the farming system.

To monitor the biofilter nitrification process, that is, the biological oxidation process by means of bacteria that convert ammonium (NH₄⁺) into nitrite (NO₂) and then into nitrate (NO₃), three water quality samples were taken daily at 9, 16 and 20 hours. Where the total ammoniacal nitrogen (TAN) (NH₄⁺—N+NH₃—N), 3 samples of nitrite nitrogen (NO₂⁻—N) and 1 sample of nitrate nitrogen (NO₃⁻—N) were measured.

Daily measurements of oxygen, temperature as well as daily feeding portions and mortality were also recorded. Furthermore, weekly measurements of other water indicators, such as chemical profile levels of water, biological oxygen demand (BOD), biochemical oxygen demand (COD) were carried out.

### Methodology

Before beginning the bioassay, the selected fish had an acclimatization period in a 5m3 tank in room 5A in fresh water at a temperature of 14±0.2° C. and at 5 ppt of salinity, fed with a commercial diet of the Brand Skretting, Nutra Parr 60, caliber 2.9 mm. Before being transferred to rooms 4A and 4B, a weight sampling was carried out to homogeneously distribute 150 fish per pond or tank.

Feeding began the day after the pond formation with a Specific Feeding Rate (SFR) of 0.7% commercial diet with approximately 43% protein. Feeding hours were from 9:00 a.m. to 4:00 p.m. Once the period ended, the unconsumed food was quantified, thereby adjusting the feeding rate for the following day considering an additional supply of 15% daily.

During the first week, the system was maintained with 100% recirculation and only the water lost in the daily feed recovery process was replaced. Based on the performance of the biofilter and the well-being of the fish, a replacement rate of 20% of the total volume of the system was considered.

TABLE 1
Fish Farming Conditions

| Aspect | Description |
|---|---|
| Test room | 4A and 4B |
| Treatments | Only under veterinary prescription |
| No. of tanks per room | 5 |
| Tank capacity | 0.5 m³ |
| No. of fish per tank | 150 |
| Initial Density (kg/m³) | 20 kg/m³ |
| Temperature (° C.) | 14.1 ± 0.4 |
| pH | 7.5 ± 0.3 |
| Salinity | 2.0 ± 1.9 ppt, keeping the inlet valves for sea |
| | and freshwater closed |
| Oxygen | 80-105% set |
| Photoperiod | 24 hours of Light |
| Exchange rate | 1.0-1.2/hour only using 1 pressure pump |
| Disinfection system | UV |
| SFR | Ad libitum |
| Food recovery | At 16:00 hrs. with the least possible loss of |
| | water. |
| Type of feeding | Automatized |
| Feeding hours | 9:00 to 16:00 hrs. |
| Water inlet | Closed Make-up, water inlet manually |
| | controlled by technician. |
| Bicarbonate | As needed by the system |
| Biofilter Washing | Biofilter washing process was not performed |
| Biofilter | Only biofilter No. 1 of each room was used |
| Biofilter retention rate | The inlet flow rate to the biofilter was |
| | regulated at 64 lt/min |
| Tank or pond cleaning | Daily routine after food recovery |
| Pressure pumps | Only 1 pressure pump was exchanged on |
| | Monday, each week |
| Return pumps | Only pump No. 1 was used |

TABLE 2
Sample Description

| Aspect | Description | Description |
|---|---|---|
| Samples | Room 4A | Room 4A |
| No. Daily Samples | 7 | 7 |
| Sampling Schedule | 9:00-16:00-20:00 | 9:00-16:00-20:00 |
| No. of TAN samples | 3 | 3 |
| No. of NO₂—N samples | 3 | 3 |
| No. of NO₃ samples | 1 | 1 |
| Sample Analysis | Daily | Daily |
| Sample point | Pre-entry of biofilter | Pre-entry of biofilter |
| External Laboratory Sample | 1 per week (Friday) | 1 per week (Friday) |

All fish included in the test (dead or alive at the end of the test) were removed by the ATC Patagonia's silage system, thus complying with the current regulations. The silage was removed by an approved company by the corresponding authority which issues a final disposal certificate.

Table 3 shows the results obtained for the concentrations of total ammoniacal nitrogen (TAN) (NH₄⁺—N+NH₃—N), nitrite nitrogen (NO₂^{'1}—N) and nitrate nitrogen (NO₃⁻—N).

TABLE 3
Summary of biofilter parameters per group

| | Control Group (Room 4A) | | | Test Group (Room 4B) | | |
|---|---|---|---|---|---|---|
| Parameter | Mean | Min | Max | Mean | Min | Max |
| TAN (mg/l) | 6.7 ± 4.2 | 0.40 | 13.15 | 6.4 ± 3.9 | 0.26 | 11.85 |
| NO₂—N (mg/l) | 1.3 ± 1.8 | 0.00 | 7.70 | 1.8 ± 2.7 | 0.00 | 9.90 |
| NO₃—N (mg/l) | 6.6 ± 8.9 | 0.00 | 24.90 | 4.3 ± 6.6 | 0.00 | 20.90 |
| NH₃—N (mg/l) | 0.07 ± 0.1 | 0.00 | 0.21 | 0.07 ± 0.1 | 0.00 | 0.20 |

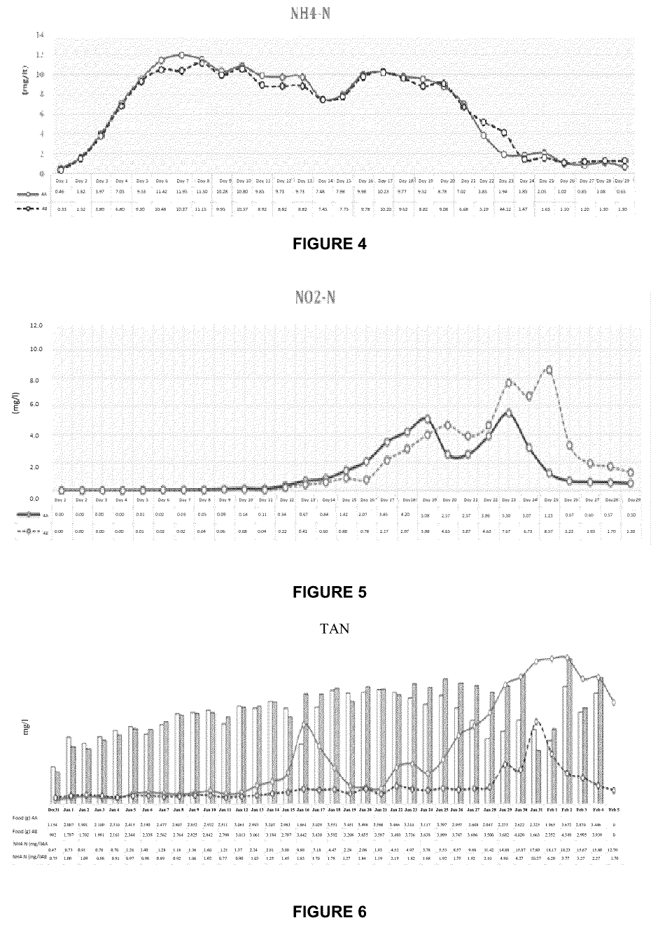

On the other hand, the results of FIGS. 4 and 5 show that considering that the biofilter was maturing or priming in this first step, the NH₄⁺y NO₂ levels do not show a significant difference since the food delivered to the fish is well below the maximum capacity of the biofilter and started with zero bacteria in the water. The biofilter showed a typical maturation period of 2 to 3 weeks, during which the NH₄⁺ concentration increased and then decreased and, the NO₂⁻ concentration began to increase later and then decreased by the third week.

### Example 2

For a second test, 750 fish of the same size (100 gr) were added to the test group room 4B and control group room 4A and farmed for another 30 days. After 21 days, NH₄⁺ levels in the control group increased beyond the biofilters ability to process said compound, causing significant suffering to fish, increased mortality, decreased feeding rate, and dangerous levels of NH₄⁺.

At the end of 35 days, the test group was being fed between 30% and 50% more than that considered for the biofilter design. The test groups on average grew a 4% faster and had an improved feeding conversion rate of 8.5%.

This second test shows that significant improvements were obtained regarding NH₄⁺ and NO₂⁻ levels, thus reducing the global level of these toxic elements for the fish by 70% and 30%, respectively.

The results obtained in this second test are shown in Tables 4 to 7 and FIGS. 6 to 8.

TABLE 4
Results on final weight of the fish

| | Number of Sampled | Weight | Standard |
|---|---|---|---|
| ROOM | Fish | (g) | Deviation |
| Control 4A | 500 | 185 | 51 |
| I | 250 | 224 | 36 |
| II | 250 | 145 | 27 |
| Test 4B | 500 | 192 | 54 |
| I | 250 | 230 | 43 |
| II | 250 | 153 | 32 |
| Total | 1.000 | 188 | 52 |

From the results shown in Table 4, it can be seen that the fish in the room of test group 4B experienced a greater weight gain, which implies that there is a more positive impact on the growth and well-being of the fish in the presence of the proposed additive.

TABLE 5
Feed conversion Ratio

| | Total Feeding | Gained Biomass | Feed Conversion |
|---|---|---|---|
| | (g) | (g) | Ratio |
| Control 4A | 138.184 | 116.278 | 1.19 |
| I | 86.334 | 80.076 | 1.08 |
| II | 51.850 | 36.202 | 1.43 |
| Test 4B | 138.300 | 126.920 | 1.09 |
| I | 86.450 | 86.316 | 1.00 |
| II | 51.850 | 40.604 | 1.28 |
| Total | 276.484 | 243.199 | 1.14 |

From the results shown in Table 5, it can be seen that the fish in test room 4B have a higher value of biomass gained, which directly affects the feed conversion ratio.

FIG. 6 shows the ammonium levels expressed as nitrogen equivalent in mg/l, the daily feed consumption per group in grams for an average of 3 samples per day for the control group 4A and test group 4B where the bars or columns represent the food consumed by the fish and the curves represent the nitrogen expressed as total ammonium (TAN). From this figure it can be seen that in the control group 4A, the bacteria consume a lower amount of ammonium than the bacteria in the test group 4B, which is due to the absence of the additive proposed in this first group.

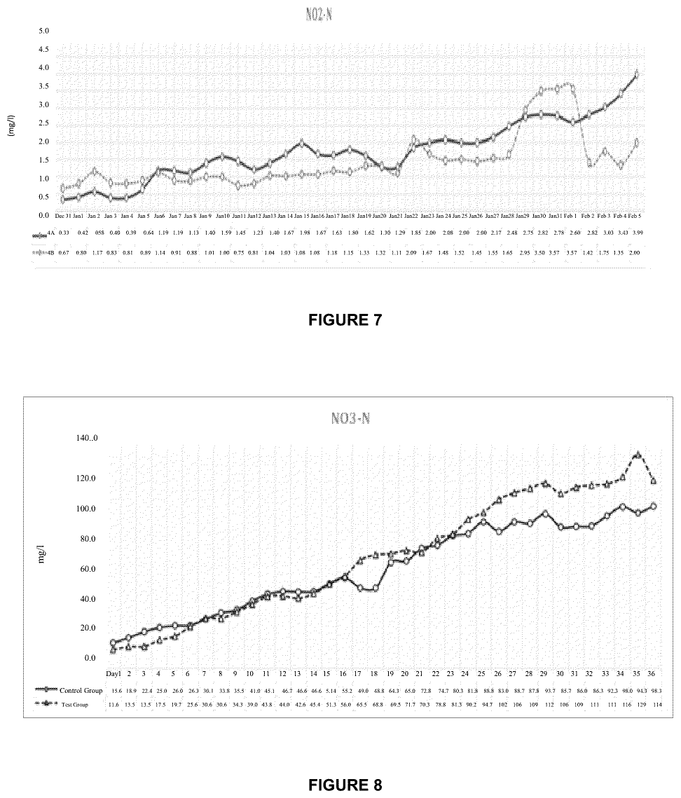

FIG. 7 shows nitrite levels expressed as mg/L nitrogen equivalent for an average of 3 samples per day for control group 4A and test group 4B. From this figure it can be seen that in the control group 4A, there is a higher concentration of nitrite than in the test group 4B, which is due to the absence of the additive proposed in this first group.

FIG. 8 shows nitrate levels expressed as mg/L nitrogen equivalent for an average of 3 samples per day for control group 4A and test group 4B. From this figure it can be seen that in the control group 4A, there is a lower concentration of nitrate than in the test group 4B, which is due to the absence of the additive proposed in this first group.

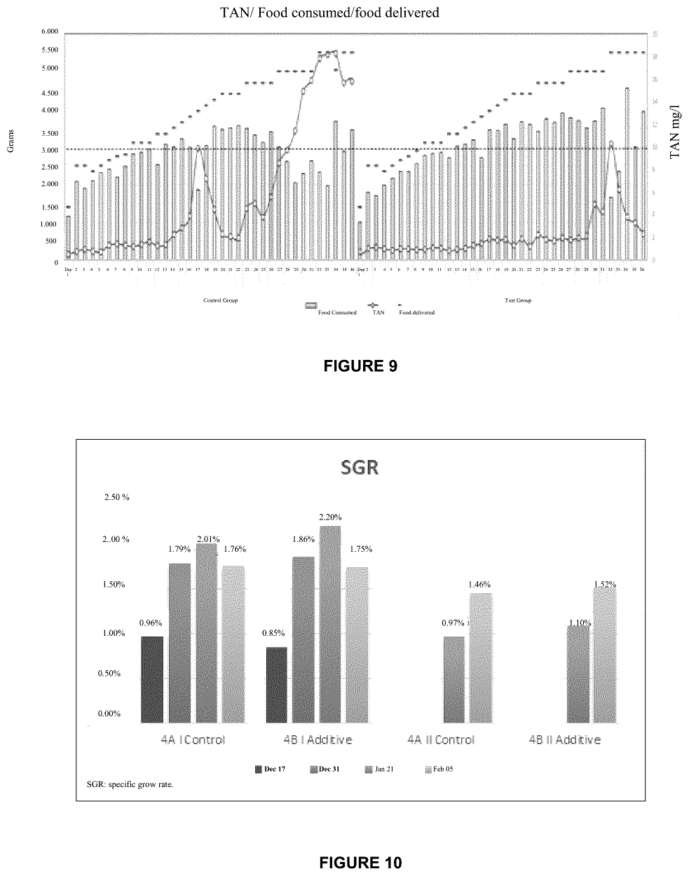

FIG. 9 clearly shows how, with an increase in the food provided to the fish, there is a point where, as the TAN (total ammonium nitrogen) increases in the control group, the food consumed decreases. In contrast, in the test group, this occurs much later and to a lesser extent due to the presence of the proposed additive. Even, the TAN level decreases when increasing the dose of the proposed additive.

FIG. 10 shows the daily growth rate of fish considering the average growth rate in 4 periods of time. From this figure it is possible to observe that the fish of test group 4B have a higher growth rate considering the same amount of food and the same amount of feeding days due to presence of the proposed additive, which has a direct impact on the system efficiency.

TABLE 6
Summary of productive parameters per group

| Group | Control 4A | Test 4B |
|---|---|---|
| Feeding days | 35 | 35 |
| No. Fish | 1.500 | 1.500 |
| Initial Weight (gr) | 106 | 107 |
| Final Weight (gr) | 185 | 192 |
| % CV Final | 27.4 | 28.2 |
| Initial Biomass (gr) | 159.109 | 159.533 |
| Final Biomass (gr) | 275.280 | 285.565 |
| Feed Delivered (gr) | 142.721 | 143.300 |
| Feeding Conversion | 1.23 | 1.14 |
| Ratio | | |
| Growth Rate | 1.57 | 1.67 |
| Mortality % | 0.2 | 0.2 |

TABLE 7
Summary of productive parameters per sub-group

| Group | Control 4A | Test 4B | Control 4A | Test 4B |
|---|---|---|---|---|
| Sub - group | 1 | 1 | 2 | 2 |
| Feeding Days | 36 | 36 | 35 | 35 |
| No. Fish | 746 | 746 | 750 | 750 |
| Initial Weight (gr) | 117 | 115 | 96 | 98 |
| Final Weight (gr) | 224 | 230 | 145 | 153 |
| Initial Biomass (gr) | 86.911 | 85.841 | 72.198 | 73.692 |
| Final Biomass (gr) | 166.953 | 171.431 | 108.255 | 114.134 |
| Feed delivered (gr) | 88.871 | 89.450 | 53.850 | 53.850 |
| Feeding Conversion | 1.11 | 1.05 | 1.49 | 1.33 |
| Rate | | | | |
| Growth Rate | 1.82 | 1.92 | 1.17 | 1.26 |
| Mortality % | 0.1 | 0.0 | 0.3 | 0.4 |

From the results shown in Tables 6 and 7 it can be clearly seen an improved growth rate and a higher food conversion ratio in the test groups 4B compared to control groups 4A due to presence of the proposed additive.

Furthermore, FIGS. 11 to 18, which are images, make it possible to see the difference in water quality and the biofilter used in the tests.

In these FIGS. 11 to 14, different points in the fish farm are compared between the control group 4A and the test group 4B. Both in the tanks and in the stripping unit, where centrifugation takes place, better water quality is achieved with lower sedimentation and greater transparency in the test group 4B.

In FIGS. 17 and 18, it can be observed that the biofilters used with the proposed additive have a greater amount of organic matter or biofilm attached, allowing for greater efficiency in bacterial activity and improving the capacity to digest undesirable chemical compounds.

The same trends are evident in the results presented in Tables 8 and 9.

TABLE 8
Total Suspended solids in bio-block g/l

| Date | Control | Additive |
|---|---|---|
| January 23 | 32.4 | 56 |
| February 01- | 85.5 | 130 |
| February 04 - | 17 | 37 |

TABLE 9
Grams of biofilm per bio block

| Date | Control | Additive |
|---|---|---|
| January 23 - | 1.08 | 1.87 |
| February 01- | 2.85 | 4.33 |
| February 04 - | 0.59 | 1.24 |

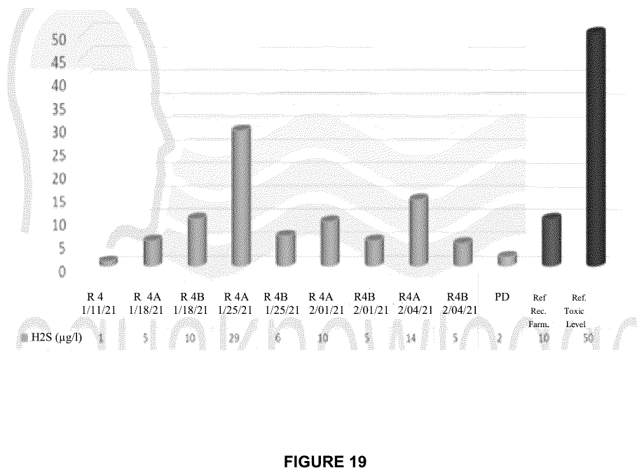

Finally, FIG. 19 shows that in the analysis of another toxic compound, such as hydrogen sulfide (H2S), the 4B room generally exhibits lower levels of H2S. This suggests that the biofilms in this room may comprise a higher proportion of aerobic microorganisms. On the other hand, in room 4A, there might be a greater amount of anaerobic biofilm, reducing the efficiency of the biofilter.

It is worth highlighting that the use of the proposed additive in a recirculating system (RAS) presents the following advantages:
(a) Better feed conversion: according to the results, the fish in room 4B achieved growth with a lower amount of food, reducing production costs.
(b) Better water quality: this implies less stress for the fish and improved sanitary conditions; and
(c) Most importantly, the ability to process NH₄⁺ more efficiently, produced in the biofilter, enabling the delivery of a greater amount of food to the fish. This will allow starting the fish farming with a larger number of fish or beginning with a smaller number of fish but achieving a larger size. In both cases, a reduction of fixed costs, investment costs, electricity costs and human resources costs is achieved.

1. An additive that improves the efficiency of a biofilter in recirculating aquaculture systems (RAS) wherein it comprises
(A) Vitamins and other organic compounds comprised of:
between 50 and 90 IU/100 mg of vitamin A,
between 0.5 and 1.0% (w/w) of amino acids,
0.01 to 0.03% (w/w) of biotin,
0.05 to 0.1% (w/w) of cysteine,
0.01% (w/w) of methionine,
less than 1 ppm of folic acid,
20 to 34 mg/100 mg of inositol,
0.0001 to 0.0002% (w/w) of vitamin B2 (riboflavin),
5 to 7.1 mg/100 mg of choline,
0.005 to 0.01% (w/w) of tryptophan,
0.0008 to 0.0016% (w/w) of vitamin B12,
0.03-0.07% w/w of Pantothenic acid,
0.002 to 0.004% (w/w) of vitamin B6,
0.002 to 0.004% (w/w) of vitamin D2 and D3; and
(B) minerals comprised of:
0.05 to 0.073% (w/w) of calcium,
0.002 to 0.005% (w/w) of iron,
1 to 200 mg/l of copper,
0.05 to 0.15% (w/w) of potassium,
0.5 to 1.0 mg/l of boron,
0.02 to 0.04% (w/w) of magnesium,
4.000 to 9.000 mg/l of manganese,
0.02 to 0.05 mg/l of molybdenum,
10 to 14 mg/l of nickel,
0.01 to 0.02 mg/l of vanadium,
4.000 to 9.500 mg/l of zinc.

2. The additive of claim 1 wherein vitamin A includes carotene B and retinol.

3. The additive of claim 1 wherein the amino acids are selected from a group consisting of alanine, arginine, aspartic acid, glutamic acid, glycine, histidine, isoleucine, leucine, phenylalanine, proline, serine, threonine, total lysine, tyrosine, and valine.

4. The additive of claim 1 wherein it has an aqueous base.

5. The use of an additive according to claim 1 wherein it serves to improve the efficiency of a biofilter in recirculating aquaculture systems (RAS) stimulating all types of bacteria.

6. The use of claim 5 wherein the additive is added between 12 to 20 ml of additive per kilo of food that is provided to the fish, depending on the monitored concentration of ammonia.

7. The use of claim 1 wherein the added additive flow has to be regulated by means a peristaltic pump and water is added to a tank that is not in direct contact with the fish, as the sump pump reservoir, rotary drum filter or biofilter.

8. The use of claim 1 wherein the stimulated bacteria are selected from a group consisting of aerobic bacteria, anaerobic bacteria, and facultative bacteria.

9. The use of claim 8 wherein the stimulated bacteria are facultative bacteria.

10. The use of claim 8 wherein the bacteria correspond to the genera of bacteria Nitrosomonas and Nitrobacter.

11. (canceled)

12. (canceled)
